(19) United States
(12) Patent Application Publication
(10) Pub. No.: US 2009/0174879 A1
(43) Pub. Date: Jul. 9, 2009

(54) APPARATUS AND METHOD FOR OPTICALLY EXAMINING SECURITY DOCUMENTS

(75) Inventors: Michael Bloss, München (DE); Martin Clara, München (DE); Wolfgang Deckenbach, Schechen (DE)

Correspondence Address: BACON & THOMAS, PLLC, 625 SLATERS LANE, FOURTH FLOOR, ALEXANDRIA, VA, 22314-1176, US

(73) Assignee: GIESECKE & DEVRIENT GMBH, Munchen (DE)

(21) Appl. No.: 12/297,161

(22) PCT Filed: Apr. 11, 2007
(86) PCT No.: PCT/EP2007/003220

§ 371 Date: Jan. 27, 2009

(30) Foreign Application Priority Data
Apr. 12, 2006 (DE) 10 2006 017 256.6
Sep. 27, 2006 (DE) 10 2006 045 624.6

(51) Int. Cl. G07D 7/12; G01J 3/40

(52) U.S. Cl. 356/71; 356/302

(57) ABSTRACT

An apparatus for optical analysis of value documents (BN) possesses a recording area (14) in which a value document (BN) is located during analysis, and a spectrographic device (16). The latter has a spatially dispersing optical device (29) for at least partly decomposing optical radiation coming from the recording area (14) into spectrally separate spectral components propagating in different directions according to the wavelength, a detection device (30) locally resolving in at least one spatial direction for detecting the spectral components, and a collimating and focusing optic (28) for collimating the optical radiation directed from the recording area (14) onto the dispersing device (29) and for focusing at least some of the spectral components formed by means of the dispersing optical device (29) onto the detection device (30).

This invention relates to an apparatus and method for optical analysis of value documents and to apparatuses for processing value documents with an inventive analysis apparatus.

Value documents are understood here to mean objects that represent for example a monetary value or an authorization and are therefore not to be producible at will by unauthorized persons. They therefore have features that are not easy to produce, in particular to copy, whose presence is an indication of authenticity, i.e. production by an authorized body. Important examples of such value documents are chip cards, coupons, vouchers, checks and in particular bank notes.

An important class of features of such value documents are optically recognizable features, which include in particular features for which luminescent substances are used that emit luminescence radiation with a characteristic spectrum upon irradiation with optical radiation of a given wavelength. Optical radiation is understood here to mean electromagnetic radiation in the ultraviolet, visible or infrared range of the electromagnetic spectrum.

For checking authenticity, a value document can be irradiated with suitable optical radiation. It is then checked by means of a suitable sensor device whether the optical radiation excites luminescence radiation at given places on or in the value document, for which purpose optical radiation emanating from the value document is analyzed spectrally. Such a check should proceed as fast as possible and with simple equipment; to give apparatuses in which an authenticity check is carried out on the basis of luminescence features as space-saving a design as possible, it is desirable that an apparatus for checking luminescence features is constructed very compactly but still possesses a sufficient spectral resolution and sensitivity to permit recognition of the presence of the characteristic luminescence spectrum.

The present invention is therefore based on the object of providing an apparatus for optical analysis of value documents that permits a very compact, space-saving structure, and of providing a corresponding method for analyzing value documents.

This object is achieved according to a first alternative by an apparatus for optical analysis of value documents with a recording area in which a value document is located during analysis, and a spectrographic device for analysis of optical radiation coming from the recording area. The spectrographic device comprises a spatially dispersing optical device for at least partly decomposing optical radiation coming from the recording area into spectrally separate spectral components propagating in different directions according to the wavelength, a detection device locally resolving in at least one spatial direction for, in particular locally resolved, detection of the spectral components, and a collimating and focusing optic for collimating the optical radiation directed from the recording area onto the dispersing device and for focusing at least some of the spectral components formed by the dispersing device onto the detection device.

This object is further achieved according to the first alternative by a method for optical analysis of a value document wherein optical radiation emanating from the value document is shaped into a parallel ray bundle by an optic, in particular a collimating and focusing optic, the ray bundle is decomposed at least partly into spectral components of different wavelengths which propagate in different directions in dependence on the wavelength, at least some of the spectral components are focused by the optic onto a detection device, and the spectral components focused onto the detection device are detected.

The inventive apparatus according to the first alternative uses for analyzing a value document in the recording area a spectral decomposition of the optical radiation emanating from the recording area, in particular a value document in the recording area, which will hereinafter also be designated as detection radiation. For this purpose, it has the spatially dispersing device which decomposes incident optical radiation at least partly into spectral components which propagate in spatially different directions depending on the wavelength of the particular spectral component. The dispersing device only needs to be able to work in a wavelength range given in dependence on the given value documents. The presence of optical radiation in a certain spatial direction and thus of the corresponding spectral component is detected by means of the locally resolving detection device, whose detection signals can be sent for at least partial recording of a spectrum of the radiation emanating from the recording area to an evaluation device and evaluated there. The recording area can be selected here in particular such that a given transport device for the value documents, for example driven belts, can transport value documents to be analyzed into the recording area.

The detection device can have in particular a plurality of detection elements for detecting optical radiation impinging in each case thereon so as to form corresponding detection signals, which are preferably disposed in the form of a row. However, it is also possible to use a two-dimensional array of detection elements.

The apparatus is characterized in particular by the fact that only one optic, the collimating and focusing optic, is used for performing two functions, namely firstly for collimating the optical radiation emanating from the recording area, in particular a value document therein, and secondly for focusing the spectrally decomposed components onto the detection device.

The proposal of this surprisingly simple structure is based on the observation that for the purpose of checking value documents a merely moderate spectral resolution, which can be simply obtained with the proposed means, is sufficient in comparison with scientific spectroscopy.

The use of only one optic for collimation and focusing further permits an at least singly folded beam path after the optic, which permits good spectral resolution at the same as a low space requirement.

Compared with another conceivable solution, namely the use of an imaging grating, there is the further advantage that the dispersing device and the collimating and focusing optic are comparatively simple components which are thus easy and economical to produce.

Furthermore, it is only necessary to adjust the collimating and focusing optic, while in constructions with separate optics for collimation and focusing two optics must be adjusted.

A further advantage of the proposed arrangement is that a very high numerical aperture of the beam path between the collimating and focusing optic can be obtained.

The collimating and focusing optic can fundamentally be configured at will. For example, it can contain at least one imaging mirror as the collimating and focusing optical component. However, to permit a beam path as simple as possible and an economical structure to be obtained, the collimating and focusing optic preferably has at least one lens, which may be a refractive lens or a diffractive optical lens.

To obtain good spectral resolution and permit a simple evaluation and calibration of the detection device, the collimating and focusing optic in the apparatus can be achromatic. This is understood to mean that said optic is corrected chromatically in the spectral range in which the spectrographic device works; the focal points for two different wavelengths in the given spectral range preferably lie one on the other. The use of an achromatic optic has the advantage that the radiation emanating from the recording area and directed onto the dispersing device is, in good approximation, not additionally split spectrally and in particular chromatic aberrations occur at the most to a small extent upon focusing of the spectral components onto the detection device. To come as close as possible, when using an entrance diaphragm or an equivalent device, to the theoretical limit of resolution given by the size of the diaphragm opening, for example the slit width in the case of a slit diaphragm, it is desirable that the circle of confusion of a pixel on the detection device resulting from color aberration in the spectral range to be detected or the working spectral range of the apparatus remains smaller than preferably ⅕, particularly preferably 1/10, of the size of the diaphragm opening.

The detection device can fundamentally be disposed and aligned at will relative to the beam path of the radiation from the recording area. However, it is preferred in the apparatus that the direction of the radiation from the recording area falling on the collimating and focusing optic is inclined relative to a surface spanned by the spectral components in the area between the collimating and focusing optic and the detection device. This embodiment permits a particularly space-saving arrangement of the detection device. In particular in the case that the spectral components span a plane as the surface, the detection device can comprise a row of detection elements extending in the direction of the plane, said row extending above or below a plane given by the beam path of the radiation emanating from the recording area. It is likewise preferred that the direction of the radiation from the recording area between the collimating and focusing optic and the dispersing device is inclined relative to a surface spanned by the spectral components in the area between the collimating and focusing optic and the dispersing device.

Further, in the apparatus, a geometric projection of the radiation coming from the recording area onto a surface spanned and limited by the spectral components falling on the detection device can be located in said surface, at least in a portion immediately before the collimating and focusing optic. This results in a particularly space-saving arrangement.

Further, there can be disposed in the apparatus in the beam path from the recording area to the spectrographic device a diaphragm disposed in the caustic surface of the collimating and focusing optic and an imaging optic for imaging the recording area onto the diaphragm. The diaphragm can be embodied in particular by a diaphragm body with a diaphragm opening or else by a beam-deflecting element or deflecting element, for example a mirror or a beam splitter, with a surface constituting a diaphragm and at least partly reflecting the detection radiation.

Particularly preferably, the detection device can then be spaced from the diaphragm in a direction extending orthogonally to the direction in which the spectral components are split. This results in a particularly compact structure of the apparatus.

The diaphragm is preferably located laterally beside the detection device here, regarded in the direction of the spatial splitting of the spectral components. Laterally can also mean above or below here, depending on the alignment of the apparatus to the ground. If a detection device with a row of detection elements is used, a perpendicular from the diaphragm onto the row preferably intersects the row itself.

The dispersing device used can fundamentally be any optical component or a combination of optical components that splits incident radiation at least partly into spectral components propagating in different directions according to the particular wavelength. For example, a prism can be used. However, the dispersing optical device of the apparatus preferably has an optical grating. The spectral components used can preferably be the spectral components of the first diffraction order, although it is also possible to use higher diffraction orders. This embodiment has the advantage that gratings are readily and economically available for any ranges of the optical spectrum, in particular for the infrared range. The grating may be any kind of grating, produced for example mechanically, lithographically or holographically.

The grating is preferably a reflection grating which directs the spectral components immediately back into the collimating and focusing optic, thereby permitting a particularly compact structure to be obtained.

Further, it is preferred that the grating is so aligned and so selected relative to the detection device that the radiation of the zeroth diffraction order does not fall on the detection device. This has the advantage that the zeroth diffraction order can optionally be used for other analyses. The grating used can be in particular an echelon grating. The echelon grating used is particularly preferably a blazed grating. This has the advantage that corresponding configuration and arrangement of the grating permits the radiation of the diffraction order given for forming the spectral components to have a particularly high intensity. The grating can be aligned with its dispersively acting line structure orthogonally to the optical axis of the collimating and focusing optic. In this case the radiation emanating from the recording area must then fall on the grating at an inclination against the optical axis. However, line structures of the grating are preferably inclined from the optical axis of the collimating and focusing optic. This permits a simple mutual adjustment of all components disposed between the recording area and the collimating and focusing optic.

Further, the dispersing optical device can be itself reflective or integrated with a reflective element, thereby reducing the number of optical components. However, it is also possible that the dispersing device used is an optical device dispersing in transmission, in which case a deflecting element, for example a mirror, is provided for reflecting the beam components generated by the device into the collimating and focusing optic.

In a particularly preferred development, the detection device has at least two edge detection elements which are so disposed that at least part of the detection beam path extends therebetween. The detection beam path from the recording area to the dispersing device extends thus at least partly through the detection device, which results in an advantageously space-saving structure.

This space-saving structure does not only result in the apparatus according to the first alternative or upon use of the collimating and focusing optic, however.

The object is instead achieved according to a second alternative more generally also by an apparatus for optical analysis of value documents with a recording area in which a value document is located during analysis, and a spectrographic device, comprising a spatially dispersing optical device for at least partly decomposing optical radiation coming from the recording area along a detection beam path into spectrally separate spectral components propagating in different directions according to the wavelength,

and a detection device locally resolving in at least one spatial direction for detecting the spectral components which has at least two edge detection elements which are so disposed that at least part of the detection beam path extends therebetween.

The detection device can in both alternatives have not only the two stated edge detection elements but also further detection elements which are disposed in a row in each case following the detection elements. The edge detection elements need not differ, except for their position, from any other detection elements present, although this is possible. The result is then a detection device with two detector rows of detection elements disposed along a row. The detector rows constitute a gap through which at least part of the detection beam path runs. The two edge detection elements are disposed on each side of the gap.

A particularly compact structure results in both alternatives when the apparatus is so configured that in the area of the two edge detection elements the detection beam path extends parallel to a surface determined by a beam path of the spectral components. In particular, the detection beam path after the two edge detection elements and the beam paths of the spectral components can extend at least partly in a plane, resulting in a particularly flat structure.

The dispersing device can fundamentally be configured in an apparatus according to the second alternative as described in the first alternative, whereby the changed beam paths must be taken into account. In particular, the dispersing device can act reflectively. If no collimating and focusing optic is used, it is particularly preferable in an apparatus according to the second alternative that the spatially dispersing optical device has an imaging dispersing element which focuses optical radiation that has passed from the recording area between the edge detection elements, split into spectral components for at least one given spectral range, onto the detection device, preferably the detection elements thereof including the edge detection elements. This embodiment offers in particular the advantage that only few parts need to be used.

For the dispersing device of the apparatus according to the second alternative, the statements on that of the first alternative apply accordingly. In particular, the dispersing optical device can preferably have an optical grating which is preferably an echelon grating, whose steps are so selected that the radiation of the zeroth diffraction order does not fall on the detection device. The use of a grating permits a particularly variable adjustment of the splitting of the spectral components. Furthermore, the grating can be simply executed as a reflection grating, resulting in a structure with few elements.

If the grating is a line grating, the line structures of the grating preferably extend orthogonally to the detection beam path immediately before the optical grating. This permits the spectral components to be directed onto the detection elements of the detection device again.

In the area between the two edge detection elements, no spectral component is detected. It is therefore preferred in an apparatus according to one of the two alternatives that a beam path from the spatially dispersing device to the detection device extends such that a spectral component of a given wavelength is directed between the two edge detection elements. In particular, the detection device, or the detection elements thereof, and the dispersing device can for this purpose be disposed relative to each other in a suitable manner. The wavelength can be given depending on the purpose of use of the apparatus. If the apparatus is to be used for example for measuring luminescence radiation or Raman radiation, the given wavelength is preferably the wavelength of the excitation radiation with which the luminescence radiation or Raman radiation is excited.

In particular for checking bank notes it is often desirable to be able to detect radiation in a spectrally resolved manner in different ranges of the optical spectrum, in particular in the visible and infrared parts of the optical spectrum. In an apparatus according to one of the two alternatives it is therefore preferred that the two edge detection elements have in each case different spectral detection ranges. If the detection device has two detector rows at whose opposite ends the two edge detection elements are disposed, the detection elements of both rows preferably have in each case the same spectral detection ranges, so that the detection ranges of the detection elements differ on the opposite sides of the gap. In particular, one detector row can have detection elements for detecting radiation at least in the visible range of optical radiation, for example based on silicon, and the other can have detection elements for detecting radiation in the infrared range of optical radiation, preferably with wavelengths greater than 900 nm, based on indium-gallium-arsenide semiconductors. This offers the advantage of a spectrally particularly broadband detection while requiring little space. In particular, the disadvantage can be overcome that detection elements based on silicon possess too little sensitivity for practical detection purposes in the spectral range with wavelengths greater than 1100 nm.

To permit a good signal-to-noise ratio to be obtained at recording times as short as possible, it is further preferred in an apparatus according to one of the two alternatives that at least some detection elements of the detection device have a sensitive surface of at least 0.1 mm². This can in particular yield considerable advantages in comparison with the use of CCD elements with respect to the signal-to-noise ratio and the recording time.

Particularly preferably, the detection device has, in particular in addition to the two edge detection elements, detection elements for simultaneously generating detection signals which represent a property, in particular the intensity, of the radiation falling thereon. This embodiment offers the advantage that the detection signals generated from the spectral components by the detection elements can be recorded simultaneously, which allows a high recording speed or repetition rate of the measurement, in particular in comparison with CCD arrays. In particular, the detection elements can be readable independently of each other or generate detection signals independently of each other.

In this case it is particularly preferable that the apparatus according to one of the two alternatives has an evaluation device connected to the detection elements via signal connections which records detection signals formed by means of the detection elements, in parallel. Such an apparatus can preferably be used to record at least one spectrum, preferably a temporal sequence of spectra, after emission of only one pulse, which is advantageous in particular for analyzing luminescence phenomena.

It proves to be very advantageous here if the evaluation device records detection signals from the detection elements of the detection device in dependence on a signal which represents the output of a pulse of illumination radiation onto the recording area. This permits an analysis of luminescence, for example of a bank note, to be effected very simply and at the same time exactly, since the time interval between pulse output and recording can be specified.

To permit a reduction of the signal-to-noise ratios of the detection by extraneous radiation to be limited or even avoided, there is disposed in the apparatuses according to the two alternatives, preferably in the detection beam path between the recording area and the spatially dispersing optical device, a filter which suppresses radiation in a given spectral range. The given spectral range can again be selected in dependence on the use of the apparatus. If the apparatus is used for example for measuring luminescence radiation or Raman radiation, the given spectral range can be for example the spectral range of the excitation radiation with which the luminescence radiation or Raman radiation is excited. It is also possible, however, to use filters that pass radiation only in a spectral range given by the spectral components to be detected but at least strongly attenuate radiation outside the range.

Further, it is preferred in an apparatus according to one of the two alternatives that there is provided in the beam path between the recording area and a space formed by the two edge detection elements, or the collimating and focusing optic, a beam splitter by means of which part of the optical radiation from the recording area can be coupled out of a beam path to the collimating and focusing optic. This has the advantage that the radiation emanating from the recording area can not only be spectrally analyzed, but also used at least partly for other analyses, for example for imaging purposes or for spectrum analysis of other spectral ranges not analyzable by means of the spectrographic device. In a particularly preferred embodiment, the above-mentioned filter is constituted by the beam splitter, which is accordingly configured for this purpose.

Depending on the type of illumination, the apparatus does not necessarily have to possess an entrance slit or, more generally, an entrance diaphragm or another device performing the same function. However, the apparatus according to one of the two alternatives preferably has at least one component performing the function of an entrance diaphragm.

Thus the apparatus can for example have an entrance diaphragm located in the plane of the detection elements at least approximatively, i.e. in the field depth range of the imaging elements disposed after the entrance slit along the beam path. Said entrance diaphragm can be provided as a separate component, but it is preferably constituted by the detection elements and/or one or more carriers for the detection elements. This results in a particularly simple structure. Upon use of a beam splitter or a beam-deflecting element in the detection beam path from the recording area to the dispersing device, the beam splitter or beam-deflecting element, for example a mirror, can likewise perform the function of the entrance slit. A particularly loss-free transfer of the detection radiation with simultaneous shielding from extraneous radiation can be obtained in an apparatus according to one of the two alternatives preferably by a light guide for guiding the detection radiation being disposed in the detection beam path, the end thereof being disposed between the two edge detection elements. The end can preferably likewise perform the function of an entrance diaphragm. A light guide is understood here in particular also to mean any element for guiding and optionally also deflecting optical radiation which is recordable in a spectrally resolved manner by means of the dispersing device and the detection device. Depending on the execution of these devices, the light guide can thus be designed in particular also for guiding invisible optical radiation in the infrared range.

Although an illumination of the recording area with ambient light is fundamentally conceivable, an apparatus according to one of the two alternatives preferably has a radiation source for emitting optical illumination radiation in at least one given wavelength range into the recording area. The illumination radiation can be used here as reflected light or transmitted light.

An apparatus according to one of the two alternatives preferably has at least one semiconductor radiation source for illuminating the recording area. The use of semiconductor radiation sources has a number of advantages. Semiconductor radiation sources thus as a rule have a considerably longer life than other radiation sources. Moreover, they require less input power for emitting optical radiation of a given power and generate less waste heat, which considerably reduces the requirements for cooling the device. Furthermore, semiconductor radiation sources are available for different wavelength ranges, so that excitation radiation can be generated simply in given wavelength ranges. Semiconductor radiation sources to be used are for example light-emitting diodes or superluminescent diodes, but preferably semiconductor lasers. Semiconductor radiation sources are understood here to mean not only components based on inorganic semiconductors but also ones based on organic substances, in particular OLEDs.

Upon use of an illumination of the recording area in reflected light, the illumination radiation can fundamentally be radiated onto the value document at an inclination therefrom. However, it is preferred that there is disposed in the beam path from the recording area to the spectrographic device a beam splitter via which optical radiation from the semiconductor radiation source passes, in particular is directed, into or onto the recording area. This has the advantage that the illumination radiation can be directed onto the value document orthogonally, so that less scattered radiation occurs that could hinder detection. It is particularly preferable to use a dichroic beam splitter for separating radiation in the area of the illumination radiation passing into the recording area from the detection radiation emanating from the value document and arranged for spectral decomposition, in a given wavelength range, which can be selected for example in dependence on at least one optical feature of the value document. This increases the signal-to-noise ratio during detection.

A further subject of the invention is an apparatus for processing value documents with an inventive apparatus according to one of the two alternatives for analyzing value documents and a transport path for value documents to be processed which leads into and/or through the recording area. The transport path can have in particular a transport device for transporting the value documents, for example driven belts. In particular, processing apparatuses that can be used are apparatuses for counting and/or sorting bank notes, automatic tellers for accepting and dispensing value documents, in particular bank notes, and apparatuses for checking the authenticity of value documents.

The invention will hereinafter be explained further by way of example with reference to the drawings. The figures show:

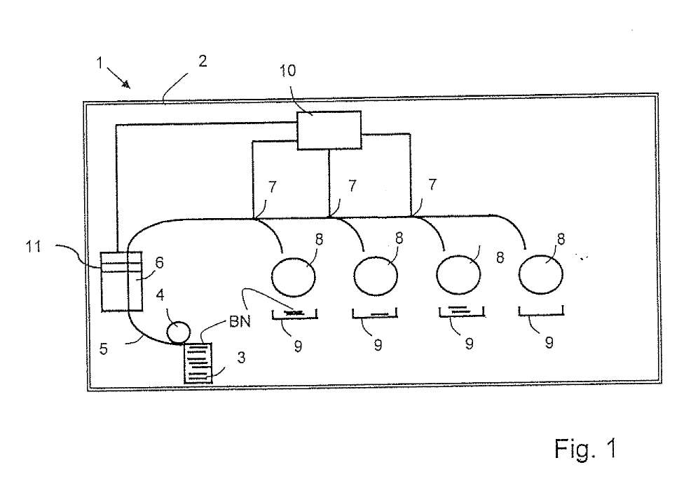

FIG. 1 a schematic representation of a bank-note sorting apparatus.

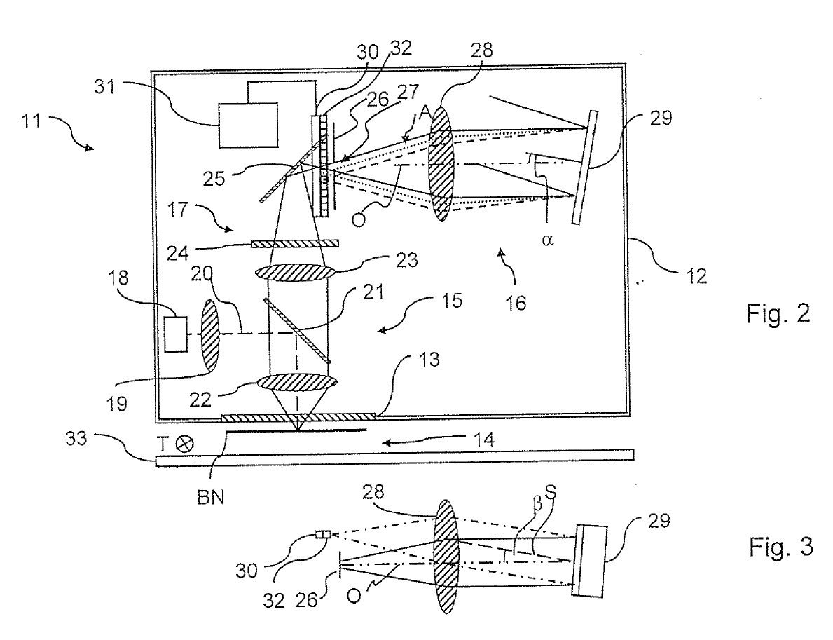

FIG. 2 a schematic plan view of an apparatus for analyzing bank notes according to a first preferred embodiment of the invention,

FIG. 3 a schematic, partial side view of the apparatus in FIG. 2,

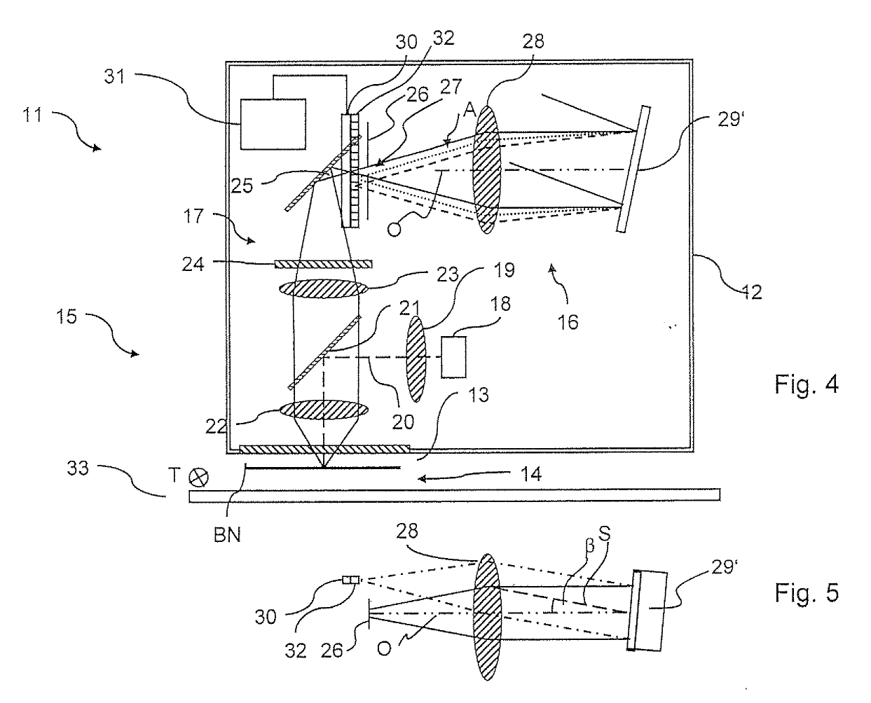

FIG. 4 a schematic plan view of an apparatus for analyzing bank notes according to a second preferred embodiment of the invention,

FIG. 5 a schematic, partial side view of the apparatus in FIG. 4,

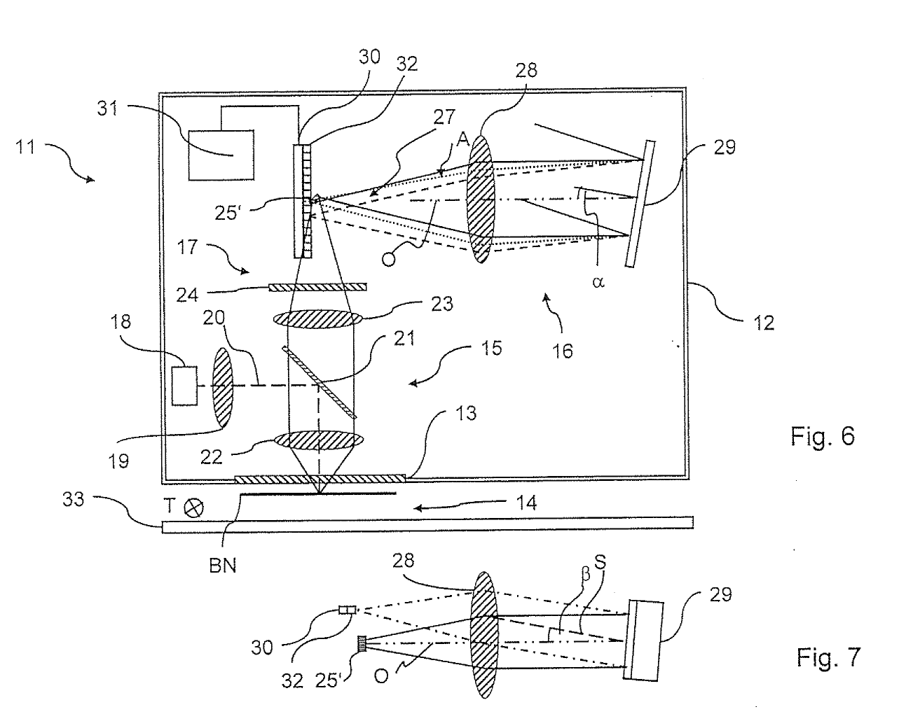

FIG. 6 a schematic plan view of an apparatus for analyzing bank notes according to a further preferred embodiment of the invention,

FIG. 7 a schematic, partial side view of the apparatus in FIG. 6,

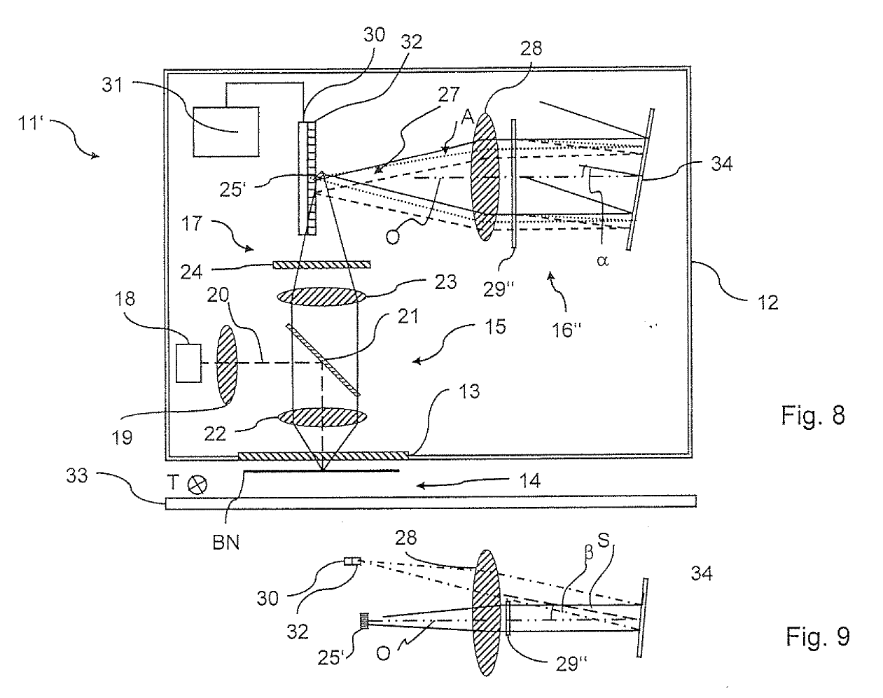

FIG. 8 a schematic plan view of an apparatus for analyzing bank notes according to yet another preferred embodiment of the invention,

FIG. 9 a schematic, partial side view of the apparatus in FIG. 8,

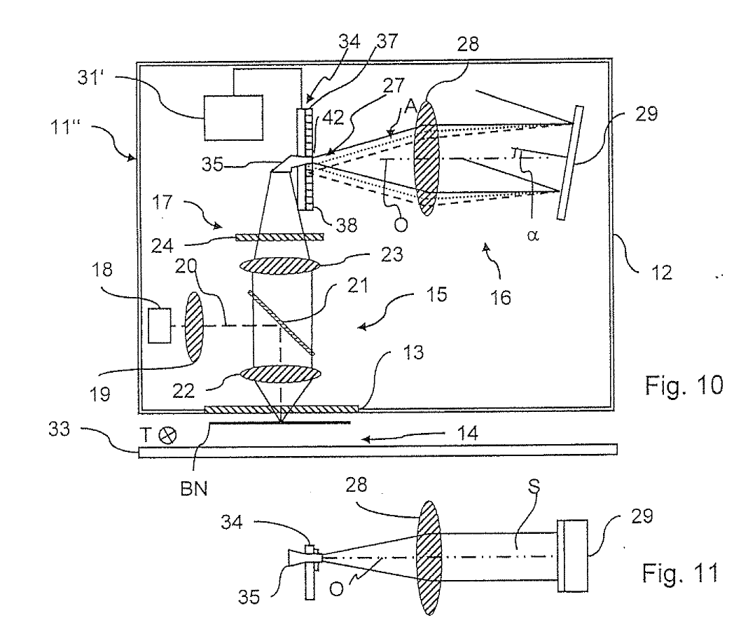

FIG. 10 a schematic plan view of an apparatus for analyzing bank notes according to a further preferred embodiment of the invention,

FIG. 11 a schematic, partial sectional view of the apparatus in FIG. 10,

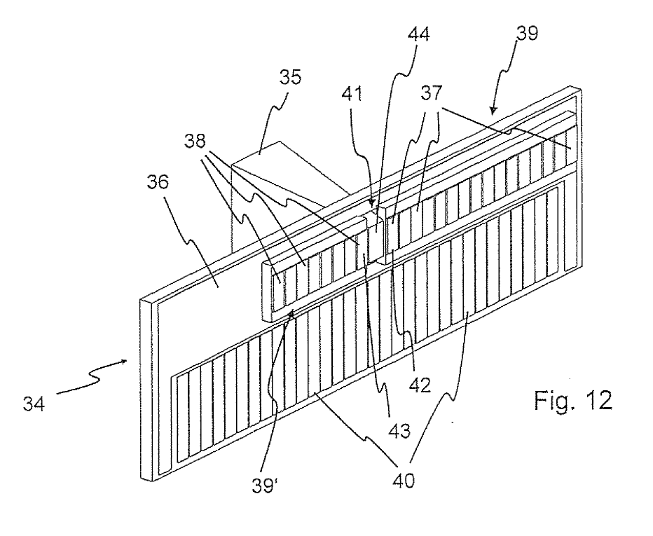

FIG. 12 a schematic perspective view of a detector arrangement with a light guide of the apparatus in FIG. 10,

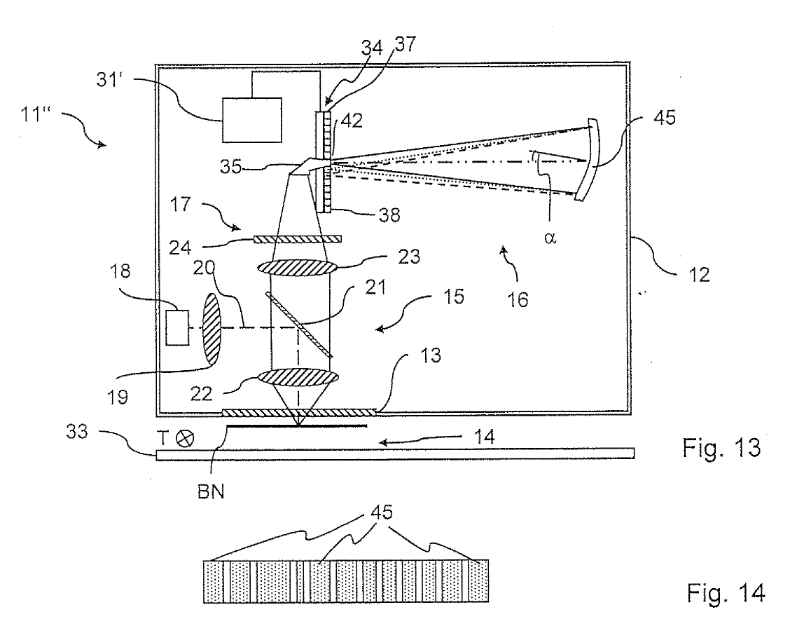

FIG. 13 a schematic plan view of an apparatus for analyzing bank notes according to yet another embodiment of the invention; and

FIG. 14 a schematic representation of an arrangement of detection elements with different widths.

FIG. 1 shows as an example of an apparatus for processing value documents a bank-note sorting apparatus 1 with an analysis apparatus according to a first preferred embodiment of the invention.

The bank-note sorting apparatus 1 has in a housing 2 an input pocket 3 for bank notes BN into which bank notes BN to be processed can be supplied as bundles either manually or automatically, optionally after a previous debanding, and then form a stack there. The bank notes BN inserted into the input pocket 3 are removed singly from the stack by a singler 4 and transported by means of a transport device 5, which defines a transport path, through a sensor device 6 which serves to analyze the bank notes. The sensor device 6 has in this exemplary embodiment a plurality of sensor modules accommodated in a common housing. The sensor modules serve to check the authenticity, state and nominal value of the checked bank notes BN. After traversing the sensor device 6 the checked bank notes BN are output in sorted fashion in dependence on the analysis results or test results of the sensor device 6 and on given sorting criteria via gates 7, which are in each case switchable back and forth between two different positions via gate-switching signals, and associated spiral slot stackers 8 into output pockets 9, from which they can be either manually removed or automatically carried off. The control of the bank-note sorting apparatus 1, in particular the conversion of analysis signals from the sensor device 6 into gate-switching signals for the gates 7, is effected by means of a control device 10.

As mentioned above, the sensor device 6 has in this exemplary embodiment different sensor modules, of which only the sensor module 11, an apparatus for analyzing value documents, in the example bank notes BN, according to a preferred embodiment of the invention, designated hereinafter as the analysis apparatus, is shown in the figures and described more exactly hereinafter. The sensor modules for recognizing the state, i.e. the fitness for circulation, and the nominal value or denomination of the bank notes BN are usual sensor modules known to the person skilled in the art and therefore need not be described more precisely.

The analysis apparatus 11 is designed in this exemplary embodiment for detecting and analyzing luminescence radiation which is excited upon illumination of given bank notes with optical radiation of a given wavelength, in the example in the infrared range of the spectrum.

The analysis apparatus 11 has a sensor housing 12 with a disk 13 transparent to the optical radiation used for analysis, which seals a window to a recording area 14 in which a bank note BN is at least partly located during an analysis. The sensor housing 12 with the disk 13 is so configured and in particular sealed that unauthorized access to the components contained therein is not possible without damaging the sensor housing 12 and/or the disk 13.

The recording area 14 delimited among other things by the arrangement and properties of the optical components of the analysis apparatus 11 is limited on the side opposite the sensor housing 12 by a fundamentally optional plate 33, so that a bank note BN can be transported, by means of the transport device 5 not shown in FIG. 2, past the disk 13 in a direction T extending orthogonally to the drawing plane in FIG. 2.

The analysis apparatus 11 has an illumination device 15 for emitting illumination radiation into the recording area 14 and in particular onto a value document, in the example a bank note BN, located at least partly in the recording area 14, and a spectrographic device 16 for analysis and in particular spectrally resolved detection of optical radiation emanating from the recording area 14 or a value document therein. In the example, the detection radiation comprises luminescence radiation in a wavelength range given by the type of value document, for example infrared luminescence radiation. This optical radiation emanating from the recording area 14 in the direction of the disk 13 will be hereinafter also designated as detection radiation. A detection optic 17 serves to couple optical radiation passing from the recording area 14 through the disk 13 into the sensor housing 12, i.e. the detection radiation, into the spectrographic device 16.

The illumination device 15 has a semiconductor radiation source 18 in the form of a semiconductor laser which, in the example, emits optical radiation in the visible range, and an illumination optic. In other exemplary embodiments the semiconductor laser can also be designed to emit radiation in the infrared range. The illumination optic possesses, in an illumination beam path, a first collimator optic 19 for forming an illumination beam or parallel illumination ray bundle 20 from the optical radiation emitted by the semiconductor radiation source 18, a dichroic beam splitter 21 which is reflective to the radiation of the illumination beam or illumination ray bundle 20 and deflects the illumination beam or illumination ray bundle 20 by 90°, in the example, onto the disk 13, and a first condenser optic 22 for focusing the illumination radiation through the disk 13 likewise constituting part of the illumination optic into the recording area 14, in particular a value document BN in the recording area 14.

The detection optic 17 comprises, along a detection beam path extending from the recording area 14 or the value document BN therein to the spectrographic device 16 and thereinto, besides the disk 13 the first condenser optic 22 which gathers radiation emanating from a point on the value document BN in the recording area 14 into a parallel ray bundle, the beam splitter 21 which is transparent to the radiation to be supplied to the spectrographic device 16 but filters illumination radiation passing into the detection beam path as scattered radiation out of the detection beam path by reflection, and a second condenser optic 23 for focusing the parallel detection radiation onto an entrance opening of the spectrographic device 16. Between the second condenser optic 23 and the spectrographic device 16 there are optionally disposed a filter 24 for filtering undesirable spectral components out of the detection beam path, in particular in the wavelength range of the illumination radiation, and a deflecting element 25, in the example a mirror, for deflecting the detection radiation by a given angle, in the example 90°. In other exemplary embodiments, the filter 24 can be disposed in the parallel beam path before the second condenser optic 23. This has the advantage that interference filters can be simply used, for example.

The spectrographic device 16 has an entrance diaphragm 26 with a diaphragm opening 27 which is slit-shaped in the exemplary embodiment, whose longitudinal extension extends at least approximatively orthogonally to the plane defined by the detection beam path.

Detection radiation entering through the diaphragm opening 27 is bundled by a collimating and focusing optic 28, which is achromatic in the example, of the spectrographic device 16. The collimating and focusing optic 28 is shown in the figures only symbolically as a lens, but is actually frequently executed as a combination of lenses. That said optic is achromatic is understood to mean that it is corrected with respect to chromatic aberrations in the wavelength range in which the spectrographic device 16 works. A corresponding correction in other wavelength ranges is unnecessary. The entrance diaphragm 26 and the collimating and focusing optic 28 are so disposed that the diaphragm opening 27 is located at least in good approximation in the caustic surface of the collimating and focusing optic 28 on the entrance-diaphragm side.

The spectrographic device 16 further has a spatially dispersing device 29, in the example an optical grating, which decomposes incident detection radiation, i.e. optical radiation coming from the recording area, at least partly into spectrally separate spectral components propagating in different directions according to the wavelength.

A detection device 30 of the spectrographic device 16 is used for detection of the spectral components that is locally resolving in at least one spatial direction. Detection signals formed upon detection are supplied to an evaluation device 31 of the spectrographic device 16, which records the detection signals and performs a comparison of the recorded spectrum with given spectra on the basis of the detection signals. The evaluation device 31 is connected to the control device 10 to transmit the result of the comparison thereto via corresponding signals.

The spatially dispersing device 29 is, in the present example, a reflection grating with a line structure whose lines extend parallel to a plane through the longitudinal direction of the diaphragm opening 27 and an optical axis of the collimating and focusing optic 28. The line spacing is so selected that the detection radiation can be spectrally decomposed in a given spectral range, in the example in the infrared. The dispersing device 29 is for this purpose so aligned that the separate spectral components, in the example the first diffraction order, are focused by the collimating and focusing optic 28 onto the detection device 30. To obtain as good a signal-to-noise ratio as possible, the line spacing and the position of the dispersing device 29 are so selected that spectrally undecomposed components of the detection radiation, in the example the zeroth diffraction order, do not fall into the collimating and focusing optic 28 but onto a radiation trap not shown in the figures, for example a plate absorbent to the detection radiation.

The detection device 30 has a row-type arrangement of detection elements 32 for the spectral components, for example a row of CCD elements, which is aligned at least approximatively parallel to the direction of spatial splitting of the spectral components, i.e. here the surface S spanned by the spectral components, in this case more precisely a plane. The plane S is illustrated in FIG. 3 by a dashed line.

To obtain as compact a structure as possible, the dispersing device 29 is firstly inclined in two directions from the detection device 30 and the direction of incident detection radiation between the collimating and focusing optic and the reflective component causing a folding of the beam path, here the dispersing device 29. Since the direction of the detection radiation between the collimating and focusing optic 28 and the reflective component, i.e. the dispersing device 29, extends parallel to the optical axis O of the collimating and focusing optic 28 in the exemplary embodiment, the plane reflection grating 29 and thus also the line structure thereof is firstly inclined from the optical axis O of the collimating and focusing optic 28 in the plane of the detection beam path. Therefore the surface S, in the example a plane, generated by the spectral components is inclined by the angle β from the direction of the detection radiation or the optical axis O of the collimating and focusing optic at least in the area between the dispersing device 29 and the collimating and focusing optic 28. In particular, a normal onto the plane reflection grating 29 in the plane of the detection beam path is inclined by an angle β from the optical axis O of the collimating and focusing optic 28 (cf. FIG. 3). Secondly, the dispersing device 16, more precisely the perpendicular of incidence for specular reflection, i.e. here the normal onto the plane of the line structure of the reflection grating 29, is inclined by an angle α from the direction of the detection radiation or the optical axis O between the collimating and focusing optic 28 and the dispersing device 29.

Secondly, the row of detection elements 32 of the detection device 30 is disposed at least approximatively in a plane with the diaphragm opening 27 and in a direction orthogonal to the plane S defined by the directions of propagation of the spectral components, spaced from the diaphragm opening 27, in FIG. 3 above the diaphragm opening 27. In FIGS. 2 and 3 the entrance diaphragm 26 and the receiving surfaces of the detection elements 32 are shown for clarity's sake spaced apart parallel to the focal plane of the collimating and focusing optic 28, but they are actually located substantially in a common plane in this example. The diaphragm opening 27 is located approximately in the middle of the row, regarded in the direction parallel to the row of detection elements 32.

It thus also results, as to be taken from FIG. 2, that in the portion between the entrance diaphragm 26 and the collimating and focusing optic 28, i.e. in particular also immediately before the collimating and focusing optic 28, a geometric projection of the detection radiation coming from the recording area 14 onto a surface A spanned and limited by the spectral components falling on the detection device 30, said surface being trapezoidal in this case, is located in said surface. This results in a particularly space-saving arrangement.

In this exemplary embodiment, the detection device 30, the entrance diaphragm 26, the collimating and focusing optic 28 and the dispersing device 29 are so configured and disposed that they are located in a circular cylindrical spatial area whose cylinder axis is given by the optical axis of the collimating and focusing optic 28, and whose cylinder diameter by the diameter of the collimating and focusing optic 28, or that of the lens or largest lens therein. The length of the circular cylindrical spatial area is preferably smaller than 50 mm, in the example 40 mm. There thus results a particularly small space requirement for the spectrographic device, while at the same time a large numerical aperture in comparison with the extension can be obtained.

For optical analysis of a value document, here a bank note BN in the recording area 14, the value document is illuminated with illumination radiation, in the example optical radiation suitable for exciting luminescence radiation from the semiconductor radiation source 18, and the optical radiation emanating from the value document, here luminescence radiation, is shaped by the detection optic 17 and the collimating and focusing optic 28 into a parallel detection ray bundle. The latter is decomposed at least partly into spectral components of different wavelengths which propagate in different directions in dependence on the wavelength. In FIG. 2 the zeroth diffraction order which is reflected without spectral splitting is shown by a continuous line, and spectral components given by the first diffraction order by dotted and dashed lines for two different wavelengths. The spectral components are focused by the collimating and focusing optic 28 onto the detection device 30, more precisely the row of detection elements 32, and detected thereby in spatially resolved fashion. Each detection element 32 is associated with a direction of propagation and thus to a spectral component in dependence on the wavelength. The evaluation device 31 therefore forms in each case from the positions of the detection elements 32 and the particular intensities recorded thereby a spectrum which can then be compared with comparison spectrums.

A second preferred embodiment in FIGS. 4 and 5 differs from the first exemplary embodiment firstly in the type of dispersing device and secondly in the arrangement of the illumination device. The same reference signs are therefore used for the same components and the comments on the first exemplary embodiment apply accordingly here too.

Instead of the plane reflection grating 29 there is now used a blazed grating 29′ whose steps are so inclined that the first diffraction order arises in the direction of specular reflection. This permits a higher intensity of the spectral components to be obtained.

In the first exemplary embodiment the illumination device can fundamentally be rotated around the optical axis of the first condenser optic 22 without the function changing. To permit as compact a design as possible to be obtained, the semiconductor radiation source 18 and the collimator optic 19 are therefore disposed beside the collimating and focusing optic 28 in this exemplary embodiment.

Further exemplary embodiments differ from the first and second exemplary embodiments in that instead of the deflecting element 25 a deflecting element 25′ is used which replaces the entrance diaphragm 26. A corresponding modification of the first exemplary embodiment is shown in FIG. 6 and FIG. 7. Therein the same reference signs as in the first exemplary embodiment are used for the same elements and the comments thereon in the first exemplary embodiment apply here too. The deflecting element 25′ is now a mirror of the size of the diaphragm opening 27 in the first exemplary embodiment and disposed in the focal plane of the collimating and focusing optic 28.

Further preferred embodiments differ from the above-described embodiments in that the detection device 30 and the entrance diaphragm 26 are integrated. For this purpose the diaphragm opening is configured in a circuit board which also bears the detection elements 32.

In other exemplary embodiments the illumination device 15 possesses as a radiation source, instead of the laser diode 18, a light-emitting diode, a superluminescent diode or an OLED.

Further, the illumination device 15 can, in other exemplary embodiments, have at least two semiconductor radiation sources which emit optical radiation at different centroid wavelengths, i.e. the average across the emission wavelengths weighted with the emission intensity, and are switchable on and off independently of each other. This permits analyses at different wavelengths to be performed successively.

In other preferred exemplary embodiments, the entrance diaphragm 26 can be completely omitted. The illumination device 15 is then so configured that it illuminates only a narrow, elongate area in the recording area, for which purpose the first condenser optic 19 can contain a cylindrical lens.

Further exemplary embodiments differ from the above-described exemplary embodiments in that further lenses are disposed in the detection beam path for reducing aberrations through the elements of the detection optic and the collimating and focusing optic 28 or improving the illumination.

Further exemplary embodiments differ from the above-described exemplary embodiments in that the deflecting element 25 or 25′ is a beam splitter, so that components of the detection radiation passing therethrough can be coupled out for example for producing an image of the value document.

In further exemplary embodiments, an illumination in transmission can also be used.

Further, it is not absolutely necessary to use a reflective dispersing optical device, such as the reflection grating 29. It is thus possible in a further exemplary embodiment, which differs from the exemplary embodiment in FIGS. 6 and 7 only in this regard, to dispose in the detection beam path after the collimating and focusing optic 28 a transmission grating 29″ which decomposes the detection radiation at least partly into spectral components. The spectral components can then be reflected into the collimating and focusing optic 28 by means of at least one reflective component 34, for example a mirror, which is inclined against the plane spanned by the spectral components.

The folding of the beam path after the collimating and focusing optic makes it possible to obtain a considerably more compact design than in an also possible apparatus wherein a focusing optic and the detection device are disposed behind the trans-mission grating instead of the mirror.

In other exemplary embodiments, the sensor housing 12 and/or the plate 33 can also be configured differently or completely omitted.

Further, in other exemplary embodiments the evaluation device 31 can be integrated into the control device 10.

Other preferred embodiments differ from the above-described exemplary embodiments in that the detection device has, instead of a row of CCD elements, a row-type arrangement of photodetection elements, for example CMOS elements, or photodetection elements for detecting optical radiation in other wavelength ranges.

An exemplary embodiment for such an analysis apparatus, which can be used like all other described analysis apparatuses for example in the apparatus for processing value documents in FIG. 1, is shown in FIGS. 10 to 12.

The analysis apparatus 11″ differs from the analysis apparatus 11 in FIG. 1, besides the type of detection elements, in that the detection beam path now passes between two edge detection elements of a detection device to reach the dispersing device. In particular, the analysis apparatuses differ only in that the detection device 30 is replaced by a detection device 34, the deflecting element 25 by a light guide 35 and the evaluation device 31 by a modified evaluation device 31′. Furthermore, the dispersing device 29 is aligned differently relative to the detection device 30. Since the analysis apparatus otherwise does not differ from that of the first exemplary embodiment, the same reference signs are used for the same components and the statements thereon in the description of the first exemplary embodiment apply accordingly here too.

The detection device 34 shown more precisely in FIG. 12 now has a carrier 36, in the example a ceramic substrate, on which first detection elements 37 are disposed in a first row-type arrangement 39, and second detection elements 38 in a second row-type arrangement 39′. In this exemplary embodiment the detection elements 37 and 38 are disposed along only one straight line. In FIG. 12 below the detection elements 37 or 38 there are located contacting elements 40 connected electrically to the detection elements via an amplifier stage configured on the carrier, and connected to signal connections to form evaluation circuits or evaluation devices.

The detection elements 37 and 38 are located on opposite sides of a recess or opening 41, which is configured rectangularly in this exemplary embodiment, in the carrier 36. Between the two edge detection elements 42 and 43 there is thus a gap.

The detection elements 37 differ from the detection elements 38 by their spectral detection range.

The detection elements 37 are detection elements for detecting optical radiation in the visible spectrum and in the near infrared, i.e. up to a wavelength of 1100 nm. They have in this exemplary embodiment a useful spectral detection range between 400 nm and 1100 nm. It is possible to use for example silicon-based detection elements here.

The detection elements 38 are detection elements for detecting optical radiation in the infrared. The useful spectral detection range thereof is between 900 nm and 1700 nm in the exemplary embodiment. It is possible to use for example InGaAs-based detection elements here, which are sensitive in the spectral range above 900 nm.

The detection elements 37 and 38 are so disposed relative to the dispersing device 29 that spectral components from the dispersing device with wavelengths above 900 nm are directed onto the detection elements 38 and those with wavelengths below 900 nm onto the detection elements 37.

In comparison with CCD arrays, only a considerably smaller number of detection elements 37 or 38, for example between ten and thirty, are used, but they possess a larger detection area and a reduced proportion of non-photosensitive areas. The detection area is determined here by only optical radiation impinging thereon being recorded.

The detection areas preferably have a surface area of at least 0.1 mm²; in the example they have a height of 2 mm and a width of 1 mm, whereby non-photosensitive areas between adjacent detection elements have an extension of about 50 μm.

In this exemplary embodiment the detection elements 37 and 38 are readable singly independently of each other and in particular in parallel.

In this exemplary embodiment, the abovementioned amplifier stage comprises for this purpose an analog-digital converter for each of the detection elements, which converts analog signals from the particular detection element into a digital detection signal which represents the intensity of the radiation that has fallen on the detection area.

In the detection beam path there is disposed the light guide 35 made of a suitable transparent material, which guides entering detection radiation at least in the spectral range detectable by the analysis apparatus and deflects it in the direction of the dispersing device 29.

One end 44 of the light guide 35 through which the detection radiation exits therefrom is disposed in the opening 41 and thus in the caustic surface of the collimating and focusing optic 28. The detection beam path therefore extends between the two edge detection elements 42 and 43. The exit surface or the end 44 of the light guide 35 constitutes an entrance diaphragm or an entrance slit for the spectrographic device.

The light guide 35 is aligned relative to the optical axis O of the collimating and focusing optic 28 such that the radiation emitted through the end 44, averaged across the ray-bundle cross section, extends at least approximatively parallel to the optical axis O and orthogonally to the surface of the carrier 36 and in particular to the row-type arrangements of the detection elements.

As recognizable in FIG. 11, the dispersing device 29, in particular the grating lines thereof, are aligned orthogonally to the optical axis O in the plane shown in FIG. 11. In the plane shown in FIG. 10 orthogonal to the plane in FIG. 11, in contrast, the line structure given by the grating lines is inclined against the optical axis O.

The spectral components generated by the dispersing device 29 are therefore focused by the collimating and focusing optic 28 onto the detection device 34, more precisely the detection elements 37 and 38, which then detect the corresponding spectral components.

By the selected arrangement of light guide 35, collimating and focusing optic 28, dispersing device 29 and detection device 34 it is achieved that the detection beam path extends parallel or partly in the surface determined by the spectral components which are generated by means of the dispersing device 29.

The angle α is selected here so that a spectral component according to a given wavelength, in this example given by the application for luminescence measurements, the excitation wavelength for the luminescence, is focused into the gap between the two edge detection elements 42 and 43 and thus not detected.

As an option, the evaluation device 31′ is modified relative to the evaluation device 31 firstly in that the detection signals from the detection elements or the detection device are recordable substantially in parallel. Substantially in parallel is understood here to mean that the detection signals can differ in their time slots at least insofar as is necessary for the transfer to the evaluation device 31′ for example by means of multiplexing via a bus.

Further, the evaluation device 31′ is configured to record the detection signals from the detection device 34 upon a pulse output signal for the semiconductor radiation source 18 after a period of time given in dependence on the expected luminescence.

The thereby permitted parallel readout of the detection elements 37 and 38 permits short integration times and in particular a high repetition frequency of the measurements. This measure likewise contributes to an increase in the signal-to-noise ratio.

In particular, this analysis apparatus can be used for carrying out a so-called single-shot measurement by which a single measurement of the spectral properties of the luminescence radiation is carried out upon only one illumination or excitation pulse, said measurement having a precision sufficient for evaluation.

Further, the evaluation device 31′ can optionally be so configured that the analysis apparatus can be used for recording multiply in time sequence the detection signals from the detection elements and thus a plurality of spectra after output of an excitation pulse by the semiconductor radiation source, and thus for carrying out an evaluation of the time development of the spectrum.

Yet another embodiment in FIG. 13 differs from the last-described exemplary embodiment in FIGS. 10 to 12 only in that the collimating and focusing optic 28 and the dispersing device 29 in the form of a plane reflection grating are replaced by an imaging dispersing element 45 which performs the function thereof. All other parts and components are unchanged so that the same reference signs are used therefor and the statements on the last exemplary embodiment apply here too.

The imaging dispersing element now used is a holographic grating 45 which images the entrance diaphragm 44, in the example the end 44 of the light guide 35, onto the detection elements 37 or 38 in a spectrally resolved manner.

The imaging grating 45 has in the example preferably more than about 300, particularly preferably more than about 500, lines per mm, i.e. diffraction elements, to permit a sufficient dispersion of the luminescence radiation onto the detector element 21 despite the compact structure. The distance between imaging grating 45 and the detection device 34 is preferably less than about 70 mm, particularly preferably less than about 50 mm.

In other exemplary embodiments, it can also be provided that individual detection elements 45 have different dimensions, in particular in the dispersion direction of the spectral components, as shown in FIG. 14 by way of example. Since normally not all wavelengths of the spectrum or only wavelength ranges of equal width are evaluated, but rather selectively only individual wavelengths or wavelength ranges also of different width, the detection elements can be designed to be adapted in their width, parallel to the plane defined by the spectral components, to the particular wavelengths or wavelength ranges to be evaluated.

In yet other exemplary embodiments, in particular in ones where a collimating and focusing optic is used, there can be disposed before the detection device or a row of detection elements a cylindrical lens which focuses detection radiation onto the detection elements and whose cylinder axis is aligned for this purpose parallel to the row.

By means of such a cylindrical lens the portion of the recording area used for detection can be enlarged in a direction corresponding to a direction orthogonal to the cylinder axis of the cylindrical lens, thereby increasing the intensity available for detection.

1. An apparatus for optically analyzing value documents in a recording area in which a value document is located during analysis, comprising a spectrographic device comprising a spatially dispersing optical device arranged to at least partly decompose optical radiation coming from the recording area into spectrally separate spectral components propagating in different directions according to wavelength;
a detection device arranged to spatially resolve in at least one spatial direction to detect the spectral components, and
a collimating and focusing optic arranged to collimate the optical radiation directed from the recording area onto the dispersing device and to focus at least some of the spectral components formed by the dispersing optical device onto the detection device.

2. The apparatus according to claim 1, wherein the collimating and focusing optic is achromatic.

3. The apparatus according to claim 1, wherein the direction of the radiation from the recording area impinging on the collimating and focusing optic is inclined from a surface formed by the spectral components in the area between the collimating and focusing optic and the detection device.

4. The apparatus according to claim 1, wherein at least in a portion immediately before the collimating and focusing optic, a geometric projection of the radiation coming from the recording area onto a surface formed and limited by the spectral components impinging on the detection device is located on said surface.

5. The apparatus according to claim 1, wherein a diaphragm disposed in the focal surface of the collimating and focusing optic and an imaging optic for imaging the recording area onto the diaphragm are disposed in the beam path from the recording area to the spectrographic device.

6. The apparatus according to claim 1, wherein the detection device is spaced from the diaphragm in a direction which extends orthogonally to the direction in which the spectral components are separated.

7. The apparatus according to claim 1, wherein the dispersing optical device has an optical grating.

8. The apparatus according to claim 7, wherein the grating is so configured and so selected that the radiation of the zeroth diffraction order does not impinge on the detection device.

9. The apparatus according to claim 7, wherein the line structures of the grating are inclined from an optical axis of the collimating and focusing optic.

10. The apparatus according to claim 1, wherein the detection device has at least two edge detection elements which are so disposed that at least part of the detection beam path extends therebetween.

11. An apparatus for optical analysis of value documents in a recording area in which a value document is located during analysis, comprising a spectrographic device comprising a spatially dispersing optical device arranged to at least partly decompose optical radiation coming from the recording area along a detection beam path into spectrally separate spectral components propagating in different directions according to wavelength, and
a detection device arranged to spatially resolve in at least one spatial direction to detect the spectral components and which has at least two edge detection elements which are so disposed that at least part of the detection beam path extends therebetween.

12. The apparatus according to claim 1, wherein in the area of the two edge detection elements the detection beam path extends parallel to a surface determined by a beam path of the spectral components.

13. The apparatus according to claim 11, wherein the spatially dispersing optical device has an imaging dispersing element which is arranged to focus optical radiation that has passed from the recording area between the edge detection elements and split into spectral components for at least one given spectral range on to the detection device.

14. The apparatus according to claim 10, wherein the dispersing optical device has an optical grating which is so aligned and so selected that the radiation of the zeroth diffraction order of the grating does not impinge on the detection device.

15. The apparatus according to claim 10, wherein a beam path from the spatially dispersing device to the detection device extends such that a spectral component of a given wavelength is directed between the two edge detection elements.

16. The apparatus according to claim 10, wherein the at least two edge detection elements have in each case different spectral detection ranges.

17. The apparatus according to claim 1, wherein a filter which suppresses radiation in a given spectral range is disposed in the detection beam path between the recording area and the spatially dispersing optical device.

18. The apparatus according to claim 10, wherein a beam splitter by means of which part of the optical radiation from the recording area can be coupled out of the detection beam path is provided in the detection beam path between the recording area and a space formed by the two edge detection elements, or the collimating and focusing optic.

19. The apparatus according to claim 10, including a light guide arranged so the detection radiation is disposed in the detection beam path, the end of said light guide being disposed between the two edge detection elements.

20. The apparatus according to claim 1, wherein at least some of the detection elements of the detection device have a sensitive surface area of at least 0.1 mm².

21. The apparatus according to claim 10, wherein the detection device has, in particular in addition to the two edge detection elements, detection elements arranged to simultaneously generate detection signals which represent a property of radiation impinging thereon.

22. The apparatus according to claim 1, including an evaluation device connected to detection elements of the detecting device via signal connections and which in parallel records detection signals formed by means of the detection elements.

23. The apparatus according to claim 1, wherein the evaluation device records detection signals from detection elements of the detection device in dependence on a signal which represents the output of a pulse of illumination radiation onto the recording area.

24. The apparatus according to claim 1, including at least one semiconductor radiation source arranged to illuminate the recording area.

25. The apparatus according to claim 1, wherein a beam splitter via which optical radiation from the semiconductor radiation source passes into or onto the recording area is disposed in the beam path from the recording area to the spectrographic device.

26. An apparatus for processing value documents comprising an apparatus according to claim 1 and a transport path for value documents to be processed which leads into and/or through the recording area.

27. A method for optical analysis of a value document, wherein optical radiation emanating from the value document is shaped into a parallel ray bundle by an optic, the ray bundle is decomposed at least partly into spectral components of different wavelengths which propagate in different directions in dependence on the wavelength, at least some of the spectral components are focused by the optic onto a detection device, and the spectral components focused onto the detection device are detected.
